(19) United States
(12) Patent Application Publication
(10) Pub. No.: US 2025/0297737 A1
(43) Pub. Date: Sep. 25, 2025

(54) METHOD AND SYSTEM FOR OXYGEN BOOSTED FLUE GAS RECYCLING TO FACILITE CARBON CAPTURE IN AN AIR FIRED BURNER

(71) Applicant: Honeywell International Inc., Charlotte, NC (US)

(72) Inventors: Curtis Taylor, Fishers, IN (US); Umesh Bhayaraju, Indianapolis, IN (US)

(21) Appl. No.: 18/609,365

(22) Filed: Mar. 19, 2024

(51) Int. Cl. F23N 5/00; B01D 53/26; F23C 9/00; F23L 7/00

(52) U.S. Cl. CPC F23N 5/006; B01D 53/265; F23C 9/00; F23L 7/007; B01D 2257/504; B01D 2257/80; B01D 2258/0283; F23N 2235/06

(57) ABSTRACT

An air fired burner may be operated by controlling a composition of the burner air flow that is provided to a burner air intake of the burner, including initially having at least a majority proportion of atmospheric air, and over time, reducing the proportion of atmospheric air in the burner air flow and increasing a proportion of a synthetic air that is derived at least in part from the exhaust gas flow produced by the burner, until the proportion of atmospheric air in the burner air flow is reduced to a minimal proportion, wherein as the proportion of atmospheric air is reduced and the proportion of the synthetic air is increased, a carbon dioxide concentration of the exhaust gas flow increases.

### TECHNICAL FIELD

The present disclosure relates generally to air fired fuel burners, and more particularly to methods and systems for facilitating carbon capture in air fired fuel burners.

### BACKGROUND

Air fired burners combine atmospheric air and a fuel source to generate heat. The fuel source is a hydrocarbon such as natural gas. Combustion of hydrocarbon produce a variety of combustion products, some of which include carbon dioxide and methane. Carbon dioxide may be referred to as a greenhouse gas that is considered to be a primary source of global warming. There are a large number of existing air fired burners currently in use. What would be desirable is a way to capture more of the greenhouse gases such as carbon dioxide that are currently produced by air fired burners. What would be desirable is an efficient way to perform carbon capture by capturing and sequestering carbon dioxide that results from the combustion process.

### SUMMARY

The disclosure relates generally to air fired fuel burners, and more particularly to methods and systems for facilitating carbon capture in air fired fuel burners. An example may be found in a method for operating an air fired burner that receives a burner air flow and a burner fuel flow at a burner air intake and, the burner combusting an air/fuel mixture of the burner air flow and burner fuel flow producing heat and an exhaust flue gas flow. The method includes controlling a composition of the burner air flow that is provided to the burner air intake of the burner, including initially having at least a majority proportion of atmospheric air, and over time, reducing the proportion of atmospheric air in the burner air flow and increasing a proportion of a synthetic air that is derived at least in part from the exhaust gas flow produced by the burner, until the proportion of atmospheric air in the burner air flow is reduced to a minimal proportion, wherein as the proportion of atmospheric air is reduced and the proportion of the synthetic air is increased, a carbon dioxide concentration of the exhaust gas flow increases. The synthetic air is boosted with oxygen and sometimes an inert gas to facilitate combustion.

Another example may be found in a system. The example system includes an air fired burner having a burner air intake and a burner fuel intake. The burner is configured to combust an air/fuel mixture of a burner air flow received at the burner air intake and a burner fuel flow received at the burner fuel intake, producing heat and an exhaust gas flow. An air side control provides the burner air flow to the burner air intake. The air side control is configured to control a composition of the burner air flow that is provided to the burner air intake of the burner. The air side control is configured to reduce a proportion of atmospheric air in the burner air flow and increase a proportion of a synthetic air that is derived at least in part from the exhaust gas flow produced by the burner, until the proportion of atmospheric air in the burner air flow is reduced to a minimal proportion, wherein as the proportion of atmospheric air is reduced and the proportion of the synthetic air is increased, a carbon dioxide concentration of the exhaust gas flow increases. The synthetic air is boosted with oxygen and sometimes an inert gas to facilitate combustion.

Another example may be found in a non-transitory computer readable medium storing instructions that when executed by one or more processors causes the one or more processors to control one or more valves of a burner system to control a composition of a burner air flow that is provided to a burner air intake of a burner of the burner system, including controlling the one or more valves such that the burner air flow initially includes at least a majority proportion of atmospheric air, and over time, reduces the proportion of atmospheric air in the burner air flow and increases a proportion of a synthetic air that is derived at least in part from an exhaust gas flow produced by the burner, until the proportion of atmospheric air in the burner air flow is reduced to a minimal proportion, wherein as the proportion of atmospheric air is reduced and the proportion of the synthetic air is increased, a carbon dioxide concentration of the exhaust gas flow increases. The one or more processors are caused to control the one or more valves to boost the synthetic air with a boost amount of oxygen.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing features of an illustrative burner system;

FIG. 2 is a schematic block diagram showing features of an illustrative burner system at startup;

FIG. 3 is a schematic block diagram showing features of an illustrative burner system at steady state with full carbon dioxide recycle and oxygen boost;

FIG. 4 is a schematic block diagram showing features of an illustrative burner system;

FIG. 5 is a flow diagram showing an illustrative method for operating an air fired burner;

FIGS. 6A and 6B are flow diagrams that togethers show an illustrative method for operating an air fired burner; and

FIG. 7 is a flow diagram that shows an illustrative series of steps that may be carried out by one or more processors executing executable instructions stored on a computer readable storage medium.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

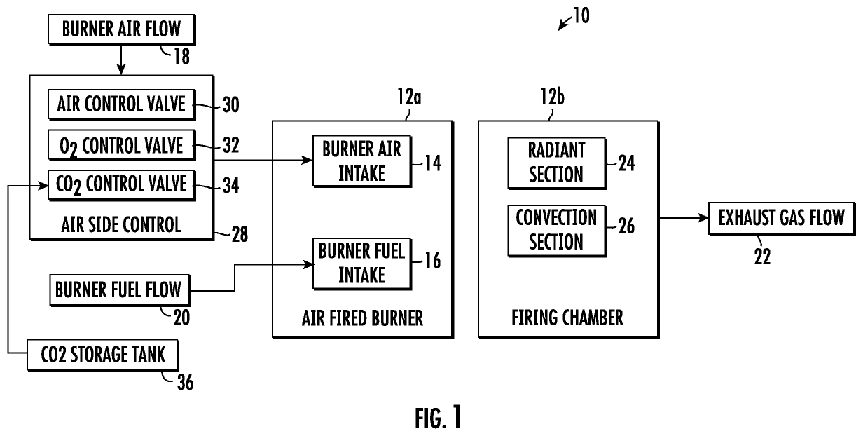

FIG. 1 is a schematic block diagram showing an illustrative burner system 10. The illustrative burner system 10 includes an air fired burner 12a and a firing chamber 12b. The air fired burner 12a includes a burner air intake 14 and a burner fuel intake 16. The air fired burner 12 is configured to combust an air/fuel mixture of a burner air flow 18 that is received at the burner air intake 14 and a burner fuel flow 20 that is received at the burner fuel intake 16, producing heat and an exhaust gas flow 22. The firing chamber 12b, which may for example be part of a heater or boiler, includes a convection section 24 and a radiant section 26. The radiant section 26 (firebox) is the combustion chamber sometimes with refractory brick walls. Radiant tubes are often suspended inside and near the walls and receive the radiant energy from the combustion process. The convection section 24 is a zone where the feed stock enters. The convection section 24 removes the heat from the flue gases and preheat the feed stock. This reduces the flue gas temperature significantly. The feed stock from the convection section 24 enters the radiant section 26. The flow rates of the combustion gases are optimized for effective heat transfer in the radiant section 26 and the convection section 24.

The burner system 10 includes an air side control 28 for providing the burner air flow 18 to the burner air intake 14. The air side control 28 may be configured to control a composition of the burner air flow 18 that is provided to the burner air intake 14 of the air fired burner 12. In some cases, the air side control 28 may be configured to reduce a proportion of atmospheric air in the burner air flow 18 and to increase a proportion of a synthetic air that is derived at least in part from the exhaust gas flow 22 produced by the air fired burner, until the proportion of atmospheric air in the burner air flow 18 is reduced to a minimal proportion, wherein as the proportion of atmospheric air is reduced and the proportion of the synthetic air is increased, a carbon dioxide concentration of the exhaust gas flow 22 increases.

In some cases, the air side control 28 may include an air control valve 30 for controlling the proportion of atmospheric air in the burner air flow 18. In some cases, the air side control 28 may include an oxygen control valve 32 for controllably boosting the synthetic air with oxygen before providing the synthetic air to the burner air intake 14 as well as a carbon dioxide control valve 34 for controllably boosting the synthetic air with carbon dioxide before providing the synthetic air to the burner air intake 14, wherein the carbon dioxide is extracted from the exhaust gas flow 22. As an example, the carbon dioxide that is extracted from the exhaust gas flow 22 may be compressed and stored in a carbon dioxide storage tank 36 prior to being added to the burner air flow 18.

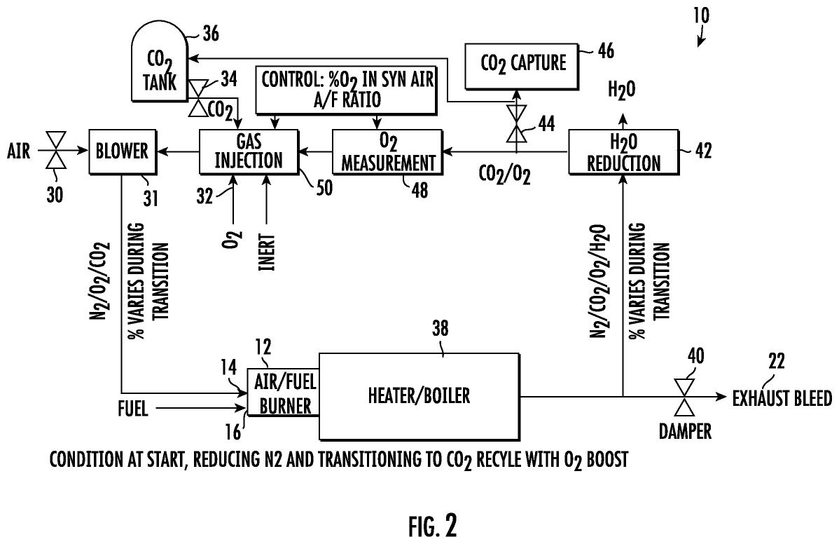

FIG. 2 is a schematic block diagram showing features of the burner system 10 at startup. The air fired burner 12 is coupled with a heater or boiler 38 that captures heat produced by the air fired burner 12. The illustrative burner system 10 includes an exhaust damper 40 that may be used to purge at least a portion of the exhaust gases exiting the air fired burner 12. At startup, and as shown in FIG. 2, the exhaust gases primarily include nitrogen, water, oxygen and carbon dioxide. The exhaust gases pass through a condenser 42 that removes the water from the exhaust gases. At this point, the exhaust gases include nitrogen, carbon dioxide and oxygen. At this point, a valve 44 that couples the exhaust gases with a carbon dioxide capture system 46 is closed, and the relative concentrations of the nitrogen, carbon dioxide and oxygen have increased, although the oxygen concentration is likely about 5 percent, as measured at an oxygen measurement point 48. The exhaust gases pass through a gas mixing chamber 50, where oxygen is added to facilitate combustion and sometimes an inert gas. At this point, the air control valve 30 providing air to a blower 31 may be partially closed to decrease the amount of fresh atmospheric air (and thus the nitrogen content) in the burner air intake 14. The reduced fresh air passing through the now partially closed air control valve 30 along with the enriched exhaust gases form a new synthetic gas for the burner having increased carbon dioxide and oxygen concentrations and a reduced nitrogen concentration.

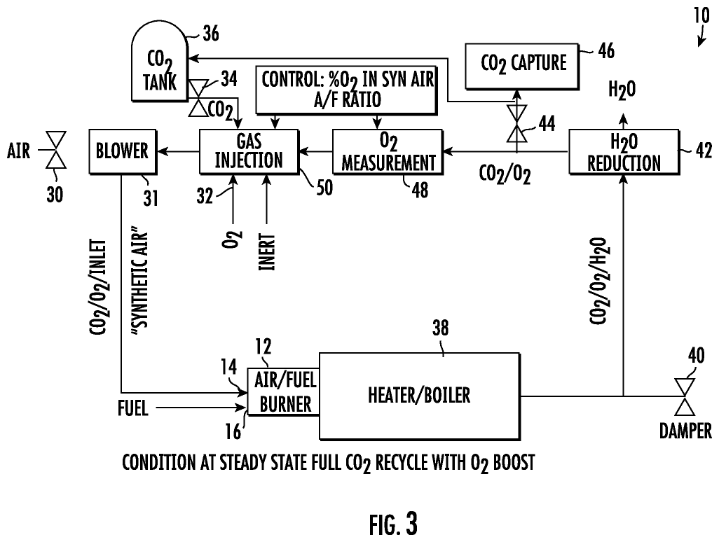

As the recycling continues of the exhaust gases and with the continued reduction of fresh atmospheric air (and thus the nitrogen content) in the burner air intake 14, a steady state may be reached, as shown in FIG. 3. At steady state, the air control valve 30 admitting fresh atmospheric air is closed, as is the exhaust damper 40. The nitrogen concentration in the synthetic gas will drop to zero or near-zero. The valve 44 will open, and carbon dioxide is compressed and transferred for subsequent sequestration processing. Some of the carbon dioxide may be compressed and stored in the carbon dioxide storage tank 36, and some of the carbon dioxide stored in the carbon dioxide storage tank 36 may be released by CO2 valve 34 to controllably boost the synthetic air with carbon dioxide before providing the synthetic air to the burner air intake 14.

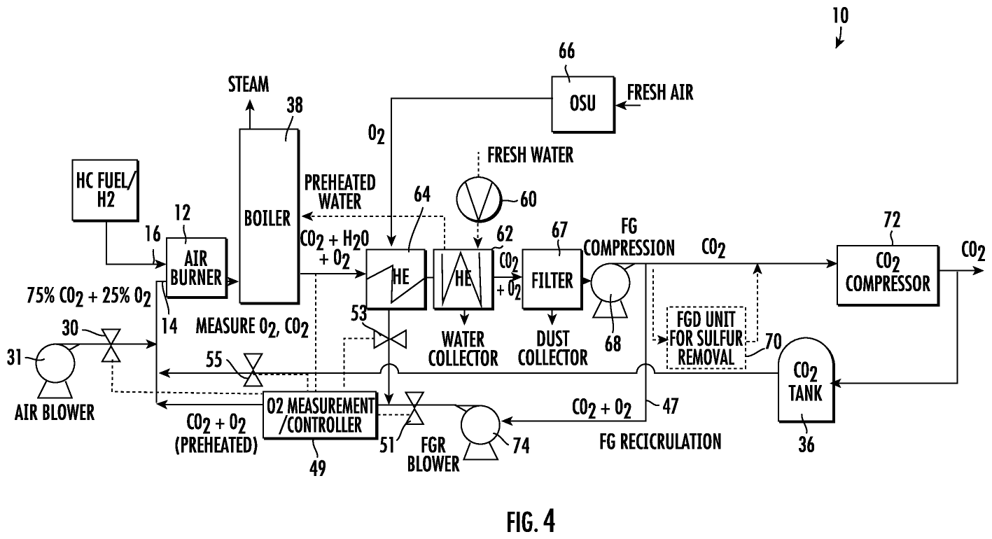

FIG. 4 is a schematic block diagram showing features of the illustrative burner system 10. In this example, a fresh water source 60 flows through a heat exchanger 62 in order to provide preheated water to the boiler 38, which produces steam. The water is heated within the heat exchanger 62 via exhaust gases. The exhaust gases exit the boiler 38 and pass through a heat exchanger 64 that preheats oxygen coming in from an Oxygen Sequestration Unit (OSU) 66, and then pass through the heat exchanger 62. The exhaust gases then pass through a filter 67 before being compressed via a compressor 68. In some cases, the burner system 10 may include an FGD unit 70 for sulfur removal. A carbon dioxide compressor 72 compresses carbon dioxide in the flue gas and provides some of the compressed carbon dioxide to the carbon dioxide storage tank 36. The carbon dioxide storage tank 36 may be released to controllably boost the synthetic air with carbon dioxide before providing the synthetic air to the burner air intake 14. An FGR blower 74 pressurizes the recycling gas. A control unit 49 receives outputs from one or more sensors, such as an oxygen sensor and a CO2 sensor, for detecting the oxygen and CO2 concentration in the current recycled flue gas 47. Based on these (and possible other) sensed values, the control unit 49 controls one or more valves to control the composition of the synthetic air that is delivered to the burner air intake 14. In the example shown, the control unit 49 controls valve 51 for controlling the flow of FG recirculation, valve 53 for controlling the flow of oxygen provided by the OSU unit 66, valve 55 for controlling the flow of CO2 from the CO2 tank 36 and valve 30 for controlling the flow of atmospheric air provided by air blower 31. The control unit 49 controls each of these valves to control the composition of the synthetic air that is delivered to the burner air intake 14 beginning at startup (e.g. FIG. 2) and continuing through steady state (e.g. FIG. 3).

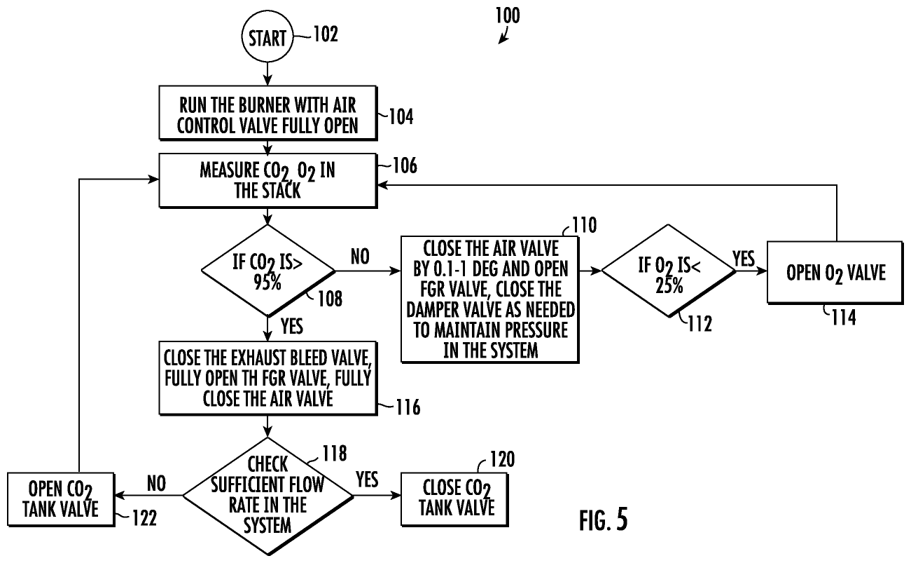

FIG. 5 is a flow diagram showing an illustrative method 100 for operating an air fired burner (such as the air fired burner 12). In some cases, this method may be used to retrofit an existing air fired burner to facilitate addition carbon capture from the existing air fired burner. Beginning at a start point 102, control passes to block 104 where the burner is run with the air control valve (such as the air control valve 30) fully open. The carbon dioxide and oxygen concentration are measured in the exhaust gas, as indicated at block 106. A determination is made as to whether the carbon dioxide concentration is greater than 95 percent, as indicated at decision block 108. If not, control passes to block 110, where the air control valve 30 is closed slightly, the Flue Gas Recirculation (FGR) valve 51 is opened slightly. In some cases, a damper valve (such as the exhaust damper 40) is closed as needed to maintain pressure in the system. A determination is then made as whether the oxygen concentration is less than 25 percent, as indicated at decision block 112. If so, control passes to block 114, and the oxygen control valve (such as the oxygen control valve 53) is opened. Control then passes back to block 106.

However, if at decision block 108 the carbon dioxide concentration is greater than 95 percent, control passes to block 116 where the exhaust damper 40 is closed, the FGR valve 51 is fully opened and the air valve 30 is fully closed. A determination is made as to whether there is sufficient flow rate in the system, as indicated at decision block 118. If so, control passes to block 120 and the carbon dioxide control valve (such as the carbon dioxide control valve 55) is closed. Otherwise, control passes to block 122 and the carbon dioxide control valve 55 is opened, followed by control reverting to block 106.

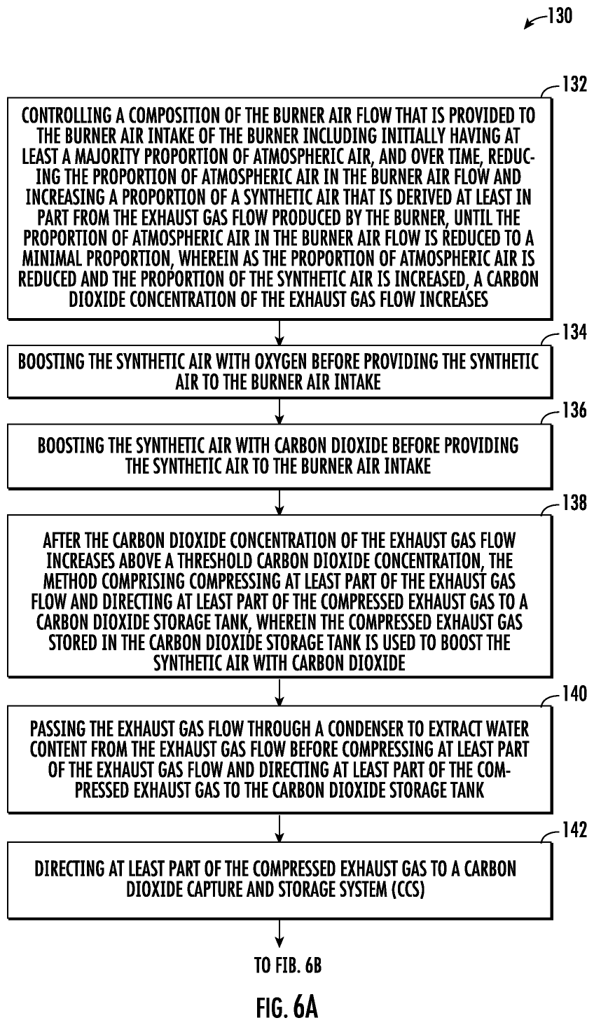

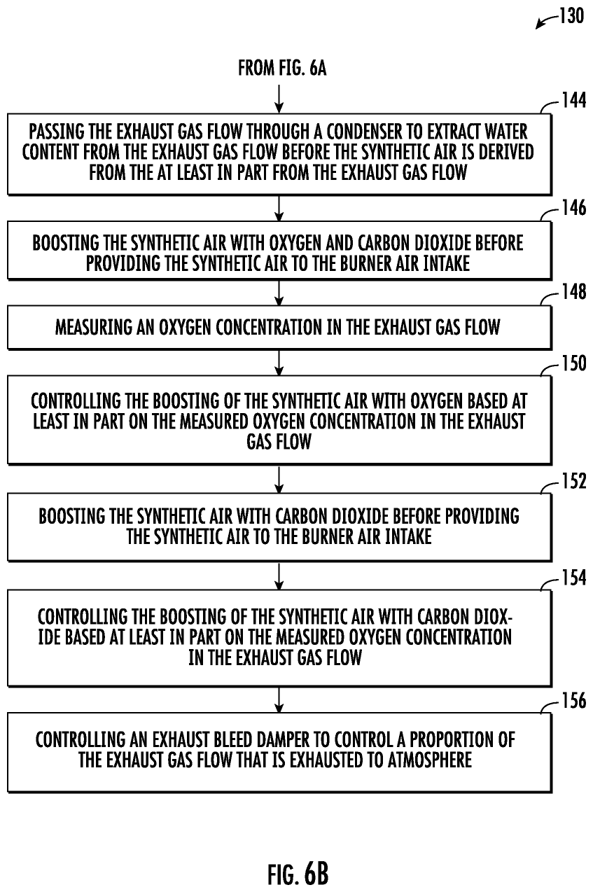

FIGS. 6A and 6B are flow diagrams that together show an illustrative method 130 for operating an air fired burner (such as the air fired burner 12), the air fired burner receiving a burner air flow (such as the burner air flow 18) at a burner air intake (such as the burner air intake 14) and a burner fuel flow (such as the burner fuel flow 20) at a burner fuel intake (such as the burner fuel intake 16), the burner combusting an air/fuel mixture of the burner air flow and burner fuel flow producing heat and an exhaust gas flow (such as the exhaust gas flow 22). The method 130 includes controlling a composition of the burner air flow that is provided to the burner air intake of the burner including initially having at least a majority proportion of atmospheric air, and over time, reducing the proportion of atmospheric air in the burner air flow and increasing a proportion of a synthetic air that is derived at least in part from the exhaust gas flow (such as exhaust gas flow 22) produced by the burner, until the proportion of atmospheric air in the burner air flow is reduced to a minimal proportion, wherein as the proportion of atmospheric air is reduced and the proportion of the synthetic air is increased, a carbon dioxide concentration of the exhaust gas flow increases, as indicated at block 132. As an example, the minimal proportion of atmospheric air may be less than 5 percent.

In some cases, the method 130 may further include boosting the synthetic air with oxygen before providing the synthetic air to the burner air intake, as indicated at block 134. In some instances, an amount that the synthetic air is boosted with oxygen may be based at least in part on a concentration of oxygen in the exhaust gas flow. In some cases, the method 130 may further include boosting the synthetic air with carbon dioxide before providing the synthetic air to the burner air intake, as indicated at block 136. In some cases, an amount that the synthetic air is boosted with carbon dioxide may be based at least in part on the proportion of synthetic air that is in the burner air flow.

After the carbon dioxide concentration of the exhaust gas flow increases above a threshold carbon dioxide concentration, the method 130 may further include compressing at least part of the exhaust gas flow and directing at least part of the compressed exhaust gas to a carbon dioxide storage tank, wherein the compressed exhaust gas stored in the carbon dioxide storage tank is used to selectively boost the synthetic air with carbon dioxide, as indicated at block 138. In some cases, the method 130 may further include passing the exhaust gas flow through a condenser to extract water content from the exhaust gas flow before compressing at least part of the exhaust gas flow and directing at least part of the compressed exhaust gas to the carbon dioxide storage tank, as indicated at block 140. At least part of the compressed exhaust gas may be directed to a carbon dioxide capture and storage system (CCS), as indicated at block 142.

Continuing on FIG. 6B, the method 130 may further include passing the exhaust gas flow through a condenser to extract water content from the exhaust gas flow before the synthetic air is derived from the at least in part from the exhaust gas flow, as indicated at block 144. The method 130 may further include boosting the synthetic air with oxygen and carbon dioxide before providing the synthetic air to the burner air intake, as indicated at block 146. In some cases, an amount that the synthetic air is boosted with carbon dioxide and/or an amount that the synthetic air is boosted with oxygen may be dependent at least in part on the proportion of synthetic air that is in the burner air flow.

In some cases, the method 130 may include measuring an oxygen concentration in the exhaust gas flow, as indicated at block 148. The boosting of the synthetic air with oxygen may be based at least in part on the measured oxygen concentration in the exhaust gas flow, as indicated at block 150. In some instances, the method 130 may further include boosting the synthetic air with carbon dioxide before providing the synthetic air to the burner air intake, as indicated at block 152. The boosting of the synthetic air with carbon dioxide may be controlled based at least in part on the measured oxygen and/or CO2 concentration in the exhaust gas flow, as indicated at block 154. In some cases, the method 130 may further include controlling an exhaust bleed damper to control a proportion of the exhaust gas flow that is exhausted to atmosphere, as indicated at block 156.

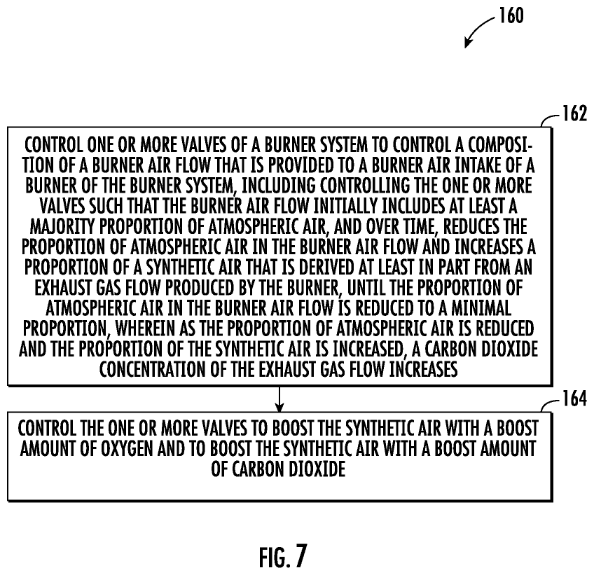

FIG. 7 is a flow diagram showing an illustrative series of steps 160 that may be carried out by one or more processors when the one or more processors execute executable instructions that are stored on a non-transitory, computer readable medium. The one or more processors may, for example be part of control unit 49. The one or more processors may be caused to control one or more valves of a burner system to control a composition of a burner air flow that is provided to a burner air intake of a burner of the burner system, including controlling the one or more valves such that the burner air flow initially includes at least a majority proportion of atmospheric air, and over time, reduces the proportion of atmospheric air in the burner air flow and increases a proportion of a synthetic air that is derived at least in part from an exhaust gas flow produced by the burner, until the proportion of atmospheric air in the burner air flow is reduced to a minimal proportion, wherein as the proportion of atmospheric air is reduced and the proportion of the synthetic air is increased, a carbon dioxide concentration of the exhaust gas flow increases, as indicated at block 162. The one or more processors may be caused to control the one or more valves to boost the synthetic air with a boost amount of oxygen and to boost the synthetic air with a boost amount of carbon dioxide, as indicated at block 164.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for operating an air fired burner, the air fired burner receiving a burner air flow at a burner air intake and a burner fuel flow at a burner fuel intake, the burner combusting an air/fuel mixture of the burner air flow and burner fuel flow producing heat and an exhaust gas flow, the method comprising:
controlling a composition of the burner air flow that is provided to the burner air intake of the burner including initially having at least a majority proportion of atmospheric air, and over time, reducing the proportion of atmospheric air in the burner air flow and increasing a proportion of a synthetic air that is derived at least in part from the exhaust gas flow produced by the burner, until the proportion of atmospheric air in the burner air flow is reduced to a minimal proportion, wherein as the proportion of atmospheric air is reduced and the proportion of the synthetic air is increased, a carbon dioxide concentration of the exhaust gas flow increases.

2. The method of claim 1, wherein the minimal proportion of atmospheric air is less than 5 percent.

3. The method of claim 1 further comprising boosting the synthetic air with oxygen before providing the synthetic air to the burner air intake.

4. The method of claim 3, wherein an amount that the synthetic air is boosted with oxygen is based at least in part on a concentration of oxygen in the exhaust gas flow.

5. The method of claim 1 further comprising boosting the synthetic air with carbon dioxide before providing the synthetic air to the burner air intake.

6. The method of claim 5, wherein an amount that the synthetic air is boosted with carbon dioxide is based at least in part on the proportion of synthetic air that is in the burner air flow.

7. The method of claim 5, wherein only after the carbon dioxide concentration of the exhaust gas flow increases above a threshold carbon dioxide concentration, the method comprising compressing at least part of the exhaust gas flow and directing at least part of the compressed exhaust gas to a carbon dioxide storage tank, wherein the compressed exhaust gas stored in the carbon dioxide storage tank is used to boost the synthetic air with carbon dioxide.

8. The method of claim 7, further comprising passing the exhaust gas flow through a condenser to extract water content from the exhaust gas flow before compressing at least part of the exhaust gas flow and directing at least part of the compressed exhaust gas to the carbon dioxide storage tank.

9. The method of claim 7, further comprising directing at least part of the compressed exhaust gas to a carbon dioxide capture and storage system (CCS).

10. The method of claim 1, further comprising passing the exhaust gas flow through a condenser to extract water content from the exhaust gas flow before the synthetic air is derived from the at least in part from the exhaust gas flow.

11. The method of claim 1 further comprising boosting the synthetic air with oxygen and carbon dioxide before providing the synthetic air to the burner air intake.

12. The method of claim 11, wherein an amount that the synthetic air is boosted with carbon dioxide and/or an amount that the synthetic air is boosted with oxygen is dependent at least in part on the proportion of synthetic air that is in the burner air flow.

13. The method of claim 3, further comprising:
measuring an oxygen concentration in the exhaust gas flow; and
controlling the boosting of the synthetic air with oxygen based at least in part on the measured oxygen concentration in the exhaust gas flow.

14. The method of claim 13, further comprising:
boosting the synthetic air with carbon dioxide before providing the synthetic air to the burner air intake; and
controlling the boosting of the synthetic air with carbon dioxide based at least in part on the measured oxygen concentration in the exhaust gas flow.

15. The method of claim 1, further comprising controlling an exhaust bleed damper to control a proportion of the exhaust gas flow that is exhausted to atmosphere.

16. A system comprising:
an air fired burner having a burner air intake and a burner fuel intake, the burner configured to combust an air/fuel mixture of a burner air flow received at the burner air intake and a burner fuel flow received at the burner fuel intake, producing heat and an exhaust gas flow;
an air side control for providing the burner air flow to the burner air intake, the air side control configured to control a composition of the burner air flow that is provided to the burner air intake of the burner; and
the air side control is configured to reduce a proportion of atmospheric air in the burner air flow and increase a proportion of a synthetic air that is derived at least in part from the exhaust gas flow produced by the burner, until the proportion of atmospheric air in the burner air flow is reduced to a minimal proportion, wherein as the proportion of atmospheric air is reduced and the proportion of the synthetic air is increased, a carbon dioxide concentration of the exhaust gas flow increases.

17. The system of claim 16, wherein the air side control includes an air control valve for controlling the proportion of atmospheric air in the burner air flow.

18. The system of claim 16, wherein the air side control includes:
an oxygen control valve for controllably boosting the synthetic air with oxygen before providing the synthetic air to the burner air intake; and
a carbon dioxide control valve for controllably boosting the synthetic air with carbon dioxide before providing the synthetic air to the burner air intake, wherein the carbon dioxide is extracted from the exhaust gas flow.

19. The system of claim 18, wherein the carbon dioxide that is extracted from the exhaust gas flow is first compressed and stored in a carbon dioxide storage tank.

20. A non-transitory computer readable medium storing instructions that when executed by one or more processors causes the one or more processors to:
control one or more valves of a burner system to control a composition of a burner air flow that is provided to a burner air intake of a burner of the burner system, including controlling the one or more valves such that the burner air flow initially includes at least a majority proportion of atmospheric air, and over time, reduces the proportion of atmospheric air in the burner air flow and increases a proportion of a synthetic air that is derived at least in part from an exhaust gas flow produced by the burner, until the proportion of atmospheric air in the burner air flow is reduced to a minimal proportion, wherein as the proportion of atmospheric air is reduced and the proportion of the synthetic air is increased, a carbon dioxide concentration of the exhaust gas flow increases; and
control the one or more valves to boost the synthetic air with a boost amount of oxygen and to boost the synthetic air with a boost amount of carbon dioxide.
